(19) United States
(12) Patent Application Publication
(10) Pub. No.: US 2026/0189856 A1
(43) Pub. Date: Jul. 2, 2026

(54) VIBRATION APPARATUS AND VEHICULAR APPARATUS COMPRISING THE SAME

(71) Applicant: LG Display Co., Ltd., Seoul (KR)

(72) Inventors: YuSeon KHO, Paju-si (KR); Seunghyun SUNG, Paju-si (KR); SeungRyull PARK, Paju-si (KR)

(73) Assignee: LG Display Co., Ltd., Seoul (KR)

(21) Appl. No.: 19/400,807

(22) Filed: Nov. 25, 2025

(30) Foreign Application Priority Data
Dec. 27, 2024 (KR) 10-2024-0199361

(51) Int. Cl. H04R 17/00

(52) U.S. Cl. CPC H04R 17/00; H04R 2499/13

(57) ABSTRACT

The present disclosure provides a vibration apparatus and vehicular apparatus comprising the same. The vibration apparatus includes a first vibration generating module with a first vibrating portion, and a second vibration generating module spaced apart from the first vibration generating module and having a second vibrating portion different from the first vibrating portion. The first and second vibration generating modules may vibrate a vibration member to output sound or haptic feedback. By providing vibrating portions of different configurations, the vibration apparatus may improve directivity, acoustic characteristics, or sound pressure characteristics, and may reduce or minimize acoustic interference between multiple vibration sources. A vehicular apparatus may include a vibration member exposed to an indoor space and a sound generating apparatus that comprises the vibration apparatus to provide sound output and haptic functionality within the vehicle.

### CROSS-REFERENCE TO RELATED APPLICATIONS

This application claims the benefit of and priority to Korean Patent Application No. 10-2024-0199361 filed on December 27, 2024, the entirety of which is hereby incorporated by reference for all purposes as if fully set forth herein.

### BACKGROUND

### Technical Field

The present disclosure relates to a vibration apparatus and vehicular apparatus comprising the same.

### Description of Related Art

Recently, there has been an increasing demand for sound apparatus or sound bars that include vibration apparatus for outputting sound through one or more speakers.

However, the sound bar has a problem of deteriorating directivity, acoustic characteristics, and/or sound pressure characteristics due to acoustic interference between multiple speakers.

### BRIEF SUMMARY

The present disclosure describes the result of various studies and experimentation undertaken to develop a vibration apparatus capable of improving directivity, acoustic characteristics, and sound pressure characteristics by addressing the above-mentioned technical problems and by preventing or minimizing acoustic interference between multiple speakers, while also enabling haptic functionality. Based on these efforts, the present disclosure provides a vibration apparatus that achieves improved directivity, acoustic characteristics, and sound pressure characteristics while simultaneously implementing haptics, as well as a vehicular apparatus incorporating this configuration.

In particular, the disclosure describes a multi module piezoelectric vibration system in which different modules include vibrating portions of intentionally different sizes. This structure allows the apparatus to provide low frequency vibrations for touch haptics as well as high frequency ultrasonic vibrations for directional audio and mid air haptics. Larger vibrating portions enhance sound pressure and tactile response, while smaller portions improve directivity and support ultrasonic beam formation. Flexible regions, laminated cover members, and supporting members with controlled dimensions improve vibration transmission, mechanical durability, and resonance tuning across modules.

By adjusting the geometry, spacing, and angular arrangement such as an angle of sixty to one hundred twenty degrees between modules, the system establishes an interaction zone suitable for mid air haptic feedback while reducing acoustic interference that commonly arises in designs that include multiple speakers. Supporting members with selected thicknesses allow vibrating portions of different sizes to emit coherent ultrasonic waves within similar resonance bands, which facilitates the formation of stable interference patterns used for mid air tactile sensations.

These configurations provide a thin, low power, multifunctional vibration apparatus suitable for integration into displays, touch panels, and vehicular systems where directional sound, immersive haptics, and simplified structural design are desirable. Collectively, the described features support improved directivity, enhanced sound pressure, reduced power consumption, and a unified architecture that enables both contact based and contactless haptic experiences.

One or more aspects of the present disclosure are directed to provide a vibration apparatus capable of preventing or minimizing acoustic interference between a plurality of speakers, and a vehicular apparatus including the same.

One or more aspects of the present disclosure are directed to provide a vibration apparatus capable of improving directivity, acoustic characteristics and/or sound pressure characteristics, and a vehicular apparatus including the same.

One or more aspects of the present disclosure are directed to provide a vibration apparatus in which mid-air haptics and/or touch haptics may be implemented, and a vehicular apparatus including the same.

Additional features, advantages, and aspects of the present disclosure are set forth in part in the present disclosure and will also be apparent from the present disclosure or may be learned by practice of the inventive concepts provided herein. Other features, advantages, and aspects of the present disclosure may be realized and attained by the descriptions provided in the present disclosure, or derivable therefrom, and claims hereof as well as the appended drawings.

To achieve these and other advantages and aspects of the present disclosure, as embodied and broadly described herein, in one or more aspects, a vibration apparatus may comprise a first vibration generating module with a first vibrating portion, and a second vibration generating module spaced apart from the first vibration generating module and having a second vibrating portion different from the first vibrating portion.

In one or more aspects, a vehicular apparatus may comprise a vibration member exposed to indoor space, and a sound generating apparatus that outputs sound to the indoor space. The sound generating apparatus may be a vibration apparatus including a first vibration generating module having a first vibrating portion, and a second vibration generating module spaced apart from the first vibration generating module and having a second vibrating portion different from the first vibrating portion.

Details of other exemplary embodiments will be included in the detailed description of the disclosure and the accompanying drawings.

According to one or more embodiments of the present disclosure, the vibration apparatus and the vehicular apparatus comprising the same may prevent or minimize acoustic interference between a plurality of speakers.

According to one or more embodiments of the present disclosure, the vibration apparatus and the vehicular apparatus comprising the same may improve directivity, acoustic characteristics and/or sound pressure characteristics, and simultaneously implement mid-air haptics and/or touch haptics.

According to one or more embodiments of the present disclosure, the vibration apparatus and the vehicular apparatus comprising the same may be driven with low power because acoustic and/or sound pressure characteristics can be improved, and power consumption can be reduced.

According to one or more embodiments of the present disclosure, the vibration apparatus and the vehicular apparatus comprising the same have the effect of simplifying the structure and facilitating design.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE SEVERAL VIEWS OF THE DRAWINGS

The accompanying drawings, which are included to provide a further understanding of the disclosure, are incorporated in and constitute a part of this disclosure, illustrate aspects and embodiments of the disclosure and together with the description serve to explain principles of the disclosure.

FIG. 1 is a diagram schematically illustrating a vibration apparatus according to an embodiment of the present disclosure.

FIG. 2 is a plan view illustrating an example of a first vibration generating module illustrated in FIG. 1 according to an embodiment of the present disclosure.

FIG. 3 is a cross-sectional view taken along the line I-I′ shown in FIG. 2 according to an embodiment of the present disclosure.

FIG. 4 is a plan view illustrating an example of a second vibration generating module illustrated in FIG. 1 according to an embodiment of the present disclosure.

FIG. 5 is a cross-sectional view taken along the line II-II′ shown in FIG. 4 according to an embodiment of the present disclosure.

FIG. 6 is a side view schematically illustrating a vibration apparatus according to another embodiment of the present disclosure.

FIG. 7 is a plan view illustrating an example of a first vibration generating module illustrated in FIG. 6 according to another embodiment of the present disclosure.

FIG. 8 is a cross-sectional view taken along the line III-III′ shown in FIG. 7 according to another embodiment of the present disclosure.

FIG. 9 is a side view schematically illustrating a vibration apparatus according to another embodiment of the present disclosure.

FIG. 10 is a diagram illustrating a vehicular apparatus according to an embodiment of the present disclosure.

Throughout the drawings and the detailed description, unless otherwise described, the same drawing reference numerals should be understood to refer to the same elements, features, and structures.

### DETAILED DESCRIPTION

Reference will now be made in detail to embodiments of the present disclosure, examples of which may be illustrated in the accompanying drawings. In the following description, when a detailed description of well-known functions or configurations related to this document is determined to unnecessarily cloud a gist of the inventive concept, the detailed description thereof will be omitted or may be briefly discussed. The progression of processing steps and/or operations described is an example; however, the sequence of steps and/or operations is not limited to that set forth herein and may be changed as is known in the art, with the exception of steps and/or operations necessarily occurring in a particular order. Like reference numerals designate like elements throughout. Names of the respective elements used in the following explanations may be selected only for convenience of writing the specification and may be thus different from those used in actual products.

Advantages and features of the present disclosure, and implementation methods thereof will be clarified through following embodiments described with reference to the accompanying drawings. The present disclosure can, however, be embodied in different forms and should not be construed as limited to the embodiments set forth herein. Rather, these embodiments are provided so that this disclosure will be thorough and complete, and will fully convey the scope of the present disclosure to those skilled in the art.

The shapes, sizes, dimensions (e.g., length, width, height, thickness, radius, diameter, area, etc.), ratios, angles, number of elements, and the like illustrated in the accompanying drawings for describing the embodiments of the present disclosure are merely examples, and the present disclosure is not limited thereto.

A dimension including size and a thickness of each component illustrated in the drawing are illustrated for convenience of description, and the present disclosure is not limited to the size and the thickness of the component illustrated, but it is to be noted that the relative dimensions

including the relative size, location, and thickness of the components illustrated in various drawings submitted herewith are part of the present disclosure.

Like reference numerals refer to like elements throughout. In the following description, when the detailed description of the relevant known function or configuration is determined to unnecessarily obscure the important point of the present disclosure, the detailed description will be omitted.

In a case where ‘comprise’, ‘have’, and ‘include’ described in the present disclosure are used, another part can be added unless ‘only-’ is used. The terms in a singular form may include plural forms unless noted to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first”, “second”, and the like can be used herein to describe various elements, these elements should not be limited by these terms. These terms are only used to distinguish one element from another and may not define any order. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e.g., layer, film, region, component, section, or the like) is described as “connected,” “coupled,” “attached,” “adhered,” or the like to another element, the element can not only be directly connected, coupled, attached, adhered, or the like to another element, but also be indirectly connected, coupled, attached, adhered, or the like to another

element with one or more intervening elements disposed or interposed between the elements, unless otherwise specified.

For the expression that an element (e.g., layer, film, region, component, section, or the like) “contacts,” “overlaps,” or the like with another element, the element can not only directly contact, overlap, or the like with another element, but also indirectly contact, overlap, or the like with another element with one or more intervening elements disposed or interposed between the elements, unless otherwise specified.

To further elaborate, as used herein, the term "connected" is intended to have the broadest possible meaning. Specifically, the phrase "A is connected to B" encompasses both a direct connection—where no intervening components or elements are present—and an indirect connection, where one or more intermediate components or elements exist between A and B. In other words, "A is connected to B" includes both direct physical or electrical coupling and indirect coupling through one or more intervening components. Unless explicitly stated otherwise, these terms do not require direct physical or electrical contact. The term "coupled" and "in contact" should be interpreted in the same manner.

The expression of a first element, a second elements “and/or” a third element should be understood as one of the first, second and third elements or as any or all combinations of the first, second and third elements. By way of example, A, B and/or C can refer to only A; only B; only C; any or some combination of A, B, and C; or all of A, B, and C.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may”.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” may apply, for example, to a separate circuit or structure, an integrated circuit, a computational block of a circuit device, or any structure configured to perform a described function as should be understood to one of ordinary skill in the art.

Rather, these embodiments may be provided so that this disclosure may be sufficiently thorough and complete to assist those skilled in the art to fully understand the scope of the present disclosure. Furthermore, the present disclosure is only defined by scopes of claims.

Features of various embodiments of the present disclosure can be partially or overall coupled to or combined with each other, and can be variously inter-operated with each other and driven technically as those skilled in the art can sufficiently understand. The embodiments of the present disclosure can be carried out independently from each other, or can be carried out together in co-dependent relationship.

Hereinafter, embodiments of the present disclosure will be described in detail with reference to the accompanying drawings. For convenience of description, a scale of each of elements shown in the accompanying drawings differs from a real scale, and thus, is not limited to a scale shown in the drawings.

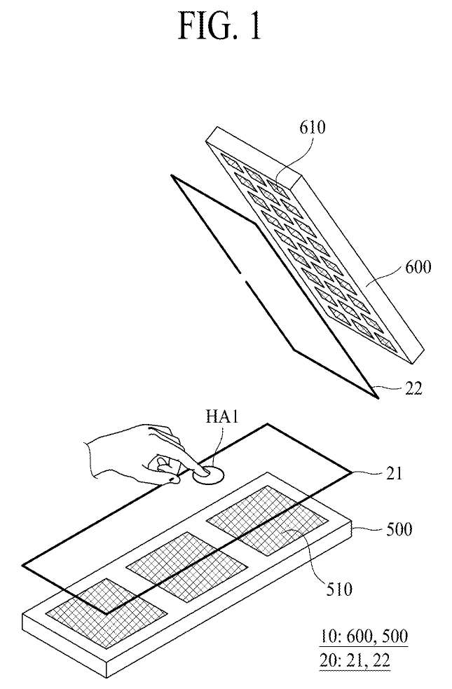

FIG. 1 is a diagram schematically illustrating a vibration apparatus according to an embodiment of the present disclosure.

Referring to FIG. 1, the vibration apparatus 10 according to an embodiment of the present disclosure may be coupled to the vibration member 20. For example, the vibration member 20 may include a first vibration member 21 and a second vibration member 22.

The first vibration member 21 and the second vibration member 22 may include any one of a diaphragm, a vibration plate, a vibration substrate, a vibration panel, a sound plate, a sound plate, a passive vibration plate, a passive vibration member, a sound output plate, a sound vibration plate, a display panel, a vehicle device, a flexible device, a curved device, a vehicle speaker member, and a directional speaker member. Since the first vibration member 21 implements the touch haptic HA1, it may further include any one of a touch plate, a touch generating member, a touch panel, a vehicle touch panel, and a touch display panel. For example, the modulus of elasticity of each of the first and second vibration members 21 and 22 may be 1.0 Gpa or more.

According to an embodiment of the present disclosure, the vibration apparatus 10 may include a first vibration generating structure 500 (also referred to as ‘a first vibration generating module 500’) and a second vibration generating structure 600 (also referred to as ‘a second vibration generating module 600’). Each of the first vibration generating module 500 and the second vibration generating module 600 may be coupled to the vibration member 20.

The first vibration generating module 500 may be connected to the first vibration member 21. The first vibration generating module 500 may be configured in the first surface (or upper surface) or the second surface (or lower surface) of the first vibration member 21. The first vibration generating module 500 may be configured to vibrate the first vibration member 21. The first vibration member 21 may generate vibration or output sound (or sound wave or sound pressure) according to driving (or vibration) of the first vibration generating module 500. The first vibration member 21 may have a size equal to or larger than that of the first vibration generating module 500. The first vibration generating module 500 may have a shape corresponding to or identical to that of the first vibration member 21, but embodiments of the present disclosure are not limited thereto.

The second vibration generating module 600 may be connected to the second vibration member 22. The second vibration generating module 600 may be configured in the first surface (or upper surface) or the second surface (or lower surface) of the second vibration member 22. The second vibration generating module 600 may be configured to vibrate the second vibration member 22. The second vibration member 22 may generate vibration or output sound (or sound wave or sound pressure) according to driving (or vibration) of the second vibration generating module 600. The second vibration member 22 may have a size equal to or larger than that of the second vibration generating module 600. The second vibration generating module 600 may correspond to or have the same shape as the second vibration member 22, but embodiments of the present disclosure are not limited thereto.

Each of the first vibration generating module 500 and the second vibration generating module 600 may include a piezoelectric material having piezoelectric characteristics. Each of the first vibration generating module 500 and the second vibration generating module 600 may vibrate (or displace or drive) the vibration member 20 according to the vibration (or drive) of the piezoelectric material according to the electrical signal (or voice signal or sound signal) applied to the piezoelectric material. For example, each of the first vibration generating module 500 and the second vibration generating module 600 may vibrate (or displace or drive) by alternately repeating contraction and/or expansion by a piezoelectric effect (or piezoelectric characteristic). For example, each of the first vibration generating module 500 and the second vibration generating module 600 may vibrate (or displace or drive) in the vertical direction (or thickness direction) (Z) by alternately repeating contraction and/or expansion by a reverse piezoelectric effect.

Each of the first vibration generating module 500 and the second vibration generating module 600 may be made of a ceramic-based piezoelectric material capable of realizing relatively high vibration, or may be made of a piezoelectric ceramic having a perovskite-based crystal structure. For example, each of the first vibration generating module 500 and the second vibration generating module 600 may be a vibration generating device, a vibration film, a vibration generating film, a vibrator, an active vibrator, an active vibration generator, an actuator, an exciter, a film actuator, a film exciter, an ultrasonic actuator, or an active vibration member, but embodiments of the present disclosure are not limited thereto.

According to an embodiment of the present disclosure, the first vibration generating module 500 and the second vibration generating module 600 may be disposed to be spaced apart from each other by a predetermined distance. Each of the first vibration generating module 500 and the second vibration generating module 600 may include a plurality of vibrating portions 510 and 610 including a piezoelectric material. The first vibration generating module 500 may include a first vibrating portion 510 including a piezoelectric material. The second vibration generating module 600 may include a second vibrating portion 610 including a piezoelectric material.

A plurality of vibrating portions or first and second vibrating portions 510 and 610 respectively configured in the first vibration generating module 500 and the second vibration generating module 600 may have different sizes. For example, the first vibrating portion 510 disposed in the first vibration generating module 500 may have a size larger than a size of the second vibrating portion 610 disposed in the second vibration generating module 600. For example, as the size of the first vibrating portion 510 increases, acoustic characteristics and/or sound pressure characteristics may be improved, and low frequency vibration may be implemented. For example, the touch haptic HA1 may be generated in a low frequency region.

The first vibration generating module 500 may output a first sound based on the first sound signal. For example, the first sound signal may include the amplitude-modulated carrier signal, but embodiments of the present disclosure are not limited thereto. For example, the first sound signal may be generated by amplitude modulation of the driving information sound signal and the carrier signal corresponding to the driving information. For example, the first sound signal may be generated by amplitude modulation of the first carrier signal based on the driving information sound signal corresponding to the driving information. For example, the first carrier signal may be a low frequency signal or a low frequency carrier signal, but embodiments of the present disclosure are not limited thereto.

According to an embodiment of the present disclosure, the first vibration generating module 500 may implement low-frequency vibrations in the range of 50 Hz to 500 Hz by including the first vibrating portion 510 having a larger size than the second vibrating portion 610. For example, the first sound may be a low-frequency vibration in the range of 50 Hz to 500 Hz. For example, when the first vibration generating module 500 implements low-frequency vibrations, the first vibration generating module 500 may be a touch generation module, a touch vibration module, or a touch sound generation module capable of generating vibrations or sounds by a user’s direct touch.

According to an embodiment of the present disclosure, the first vibration generating module 500 may implement a touch haptic HA1 that generates tactile feedback as the user directly touches the first vibration member 21. The touch haptic HA1 is to allow a user to feel vibration by touching a touch screen or a touch panel that is an input device. When the user touches the first vibration member 21, the detection sensor may detect a touch signal. The sensed touch signal may be converted into a digital form and transmitted to the control system. The control system may analyze the received information and determine what type of haptic feedback to provide. According to the determined haptic feedback, the first vibration generating module 500 may generate vibration. This process is performed simultaneously when the user touches the first vibration member 21, so that the user may feel haptic feedback at the same time as the user touches the first vibration member 21.

The second vibration generating module 600 may output a second sound having directivity based on a second sound signal different from the first sound signal. For example, the second sound signal may include the amplitude-modulated carrier signal, but embodiments of the present disclosure are not limited thereto. For example, the second sound signal may be generated by amplitude modulation of the driving information sound signal and the carrier signal corresponding to the driving information. For example, the second sound signal may be generated by amplitude modulation of the second carrier signal based on the driving information sound signal corresponding to the driving information. For example, the second carrier signal may be an ultrasonic signal or an ultrasonic carrier signal, but embodiments of the present disclosure are not limited thereto.

In the second vibration generating module 600, the second sound may implement ultrasonic vibrations in the range of 25 KHz to 60 KHz. For example, the second vibration generating module 600 may be a directional speaker implementing ultrasonic vibrations in the range of 25 KHz to 60 KHz. Accordingly, since the second sound of the second vibration generating module 600 has directivity by a carrier signal having a frequency of 25 kHz or more, it may be transmitted only to the user.

According to an embodiment of the present disclosure, the second vibrating portion 610 configured in the second vibration generating module 600 may have a size smaller than that of the first vibrating portion 510 configured in the first vibration generating module 500. For example, the smaller the size of the second vibrating portion 610, the better the directivity can be.

According to an embodiment of the present disclosure, by configuring the sizes of the first vibrating portion 510 and the second vibrating portion 610 differently, acoustic characteristics and/or sound pressure characteristics may be improved in the first vibration generating module 500, a touch haptic may be implemented, and the directivity of the vibration apparatus 10 may be improved in the second vibration generating module 600.

According to an embodiment of the present disclosure, the vibration apparatus 10 includes a first vibration generating module 500 and a second vibration generating module 600 including a piezoelectric material, so that acoustic interference between multiple speakers can be prevented or minimized.

According to an embodiment of the present disclosure, since the vibration apparatus 10 may have improved acoustic characteristics and/or sound pressure characteristics, it may be driven with low power, and has the effect of reducing power consumption.

According to an embodiment of this specification, the vibration apparatus 10 includes a first vibration generating module 500 and a second vibration generating module 600 including a piezoelectric material, thereby simplifying the structure and making it easy to design.

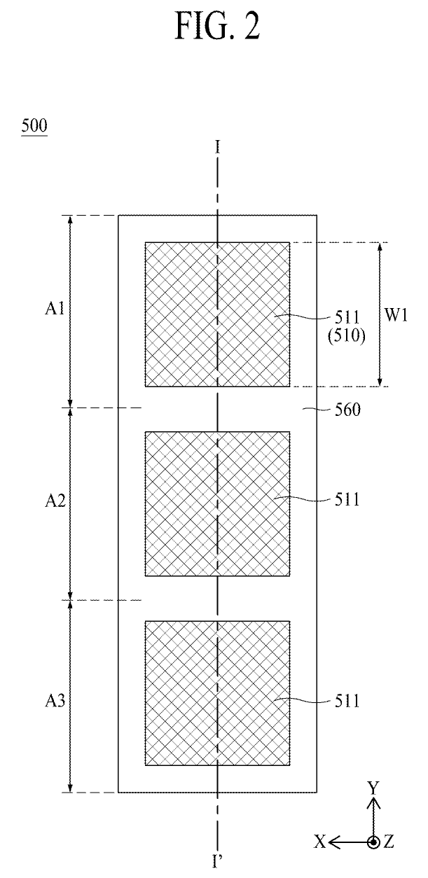

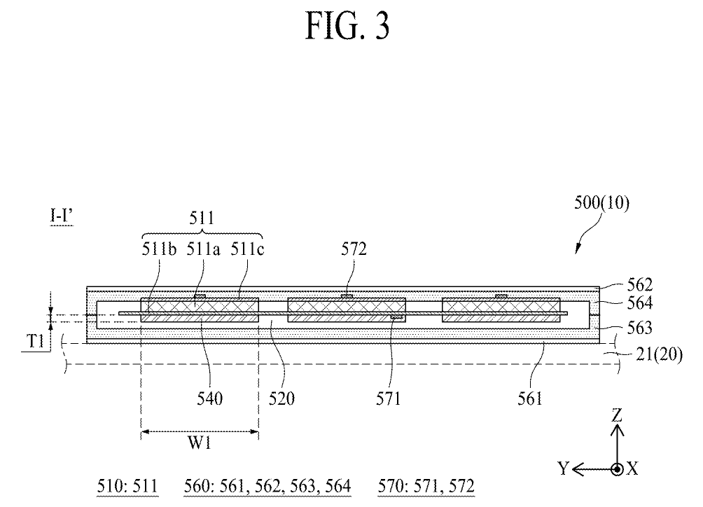

FIG. 2 is a plan view illustrating an example of a first vibration generating module illustrated in FIG. 1. FIG. 3 is a cross-sectional view taken along the line I-I′ shown in FIG. 2. It shows a first vibration generating module in an embodiment of the present disclosure described with reference to FIGS. 1 and 2.

Referring to FIGS. 1 to 3, the first vibration generating module 500 according to an embodiment of the present disclosure may include a first vibrating portion 510, a supporting member 540, a flexible portion 520, a cover member 560, and a signal cable 570.

The first vibrating portion 510 may be configured to be vibrated by a piezoelectric effect according to a driving signal. For example, the first vibrating portion 510 may include a piezoelectric type vibrating portion. The first vibrating portion 510 may include at least one of a piezoelectric inorganic material and a piezoelectric organic material, but embodiments of the present disclosure are not limited thereto.

The first vibrating portion 510 may be configured in the cover member 560. The first vibrating portion 510 may be surrounded by the cover member 560. The first vibrating portion 510 may include a plurality of first sub vibrating portions 511 configured in the cover member 560.

The cover member 560 may include first to third areas A1 to A3 having the same size. Each of the first to third areas A1 to A3 may be configured in parallel in the second direction Y perpendicular to the first direction X. The first area A1 and the third area A3 may be spaced apart from each other with the second area A2 interposed therebetween.

Each of a plurality of first sub vibrating portions 511 may be configured in first to third regions A1 to A3, respectively. Each of a plurality of first sub vibrating portions 511 may be configured in parallel in a second direction Y perpendicular to the first direction X. Each of the first sub vibrating portions 511 may be spaced apart from each other by a predetermined distance. Each of a plurality of first sub vibrating portions 511 may have a size smaller than those of the first to third regions A1 to A3.

Each of the plurality of first sub vibrating portions 511 may have the same size. For example, each of the plurality of first sub vibrating portions 511 may have a square shape, but embodiments of the present disclosure are not limited thereto. For example, the first width W1 of each of the plurality of first sub vibrating portions 511 may be 50 mm, but is not limited thereto. For example, the width, length, and thickness of each of the plurality of first sub vibrating portions 511 may be 50 mm, 50 mm, or 0.3 mm, but are not limited thereto.

According to an embodiment of the present disclosure, the first vibration generating module 500 may include a plurality of first sub vibrating portions 511 which are relatively larger than the second vibration generating module 600. For example, the first vibration generating module 500 may implement low-frequency vibrations in the range of 50 Hz to 500 Hz. For example, when low-frequency vibrations in the range of 50 Hz to 500 Hz are implemented, the first vibration generating module 500 may improve acoustic and/or sound pressure characteristics of the vibration apparatus 10, and may implement a touch haptic HA1 or a first haptic HA1 that generates tactile feedback as the user directly touches the first vibration member 21.

According to an embodiment of the present disclosure, the first sub vibrating portion 511 may include a vibrating layer 511a, a first electrode layer 511b, and a second electrode layer 511c.

The vibrating layer 511a may include a piezoelectric material including a piezoelectric effect or an electroactive material. For example, a piezoelectric material may have a characteristic in which a potential difference is generated by dielectric polarization according to a relative position change of positive (+) ions and negative (-) ions while a pressure or torsion phenomenon is applied to a crystal structure by an external force, and vibration is generated by an electric field according to an applied voltage. For example, the vibrating layer 511a may be a piezoelectric layer, a piezoelectric material layer, an electroactive layer, a piezoelectric composite layer, a piezoelectric composite, a piezoelectric ceramic composite, or the like, and embodiments of the present disclosure are not limited thereto.

The vibrating layer 511a may be formed of a ceramic-based material capable of implementing relatively high vibration or may be formed of a piezoelectric ceramic having a perovskite-based crystal structure. The perovskite crystal structure has piezoelectric and/or reverse piezoelectric effects and may be a plate-shaped structure having orientation. The perovskite crystal structure is represented by Chemical Formula of ABO₃, site A may be formed of a divalent metal element, and site B may be formed of a tetravalent metal element. In an embodiment of the present disclosure, in Chemical Formula of ABO₃, site A and site B may be cations, and site O may be anions. For example, the vibrating layer 511a may include at least one of PbTiO₃, PbZrO₃, PbZrTiO₃, BaTiO₃, and SrTiO₃, but embodiments of the present disclosure are not limited thereto.

Piezoelectric ceramic may be composed of single crystal ceramic having a single crystal structure, or ceramic material or polycrystalline ceramic having a polycrystalline structure. The piezoelectric material of the single crystal ceramic may include α-AlPO₄, α-SiO₂, LiNbO₃, Tb₂(MoO₄)₃, Li₂B₄O₇, or ZnO, but embodiments of the present disclosure are not limited thereto. The piezoelectric material of the polycrystalline ceramic may include a lead zirconate titanate (PZT)-based material including lead (Pb), zirconium (Zr), and titanium (Ti), or a lead zirconate nickel niobate (PZNN)-based material including lead (Pb), zirconium (Zr), nickel (Ni), and niobium (Nb), but embodiments of the present disclosure are not limited thereto. For example, the vibrating layer 511a may include at least one of CaTiO₃, BaTiO₃, and SrTiO₃ not including lead (Pb), but embodiments of the present disclosure are not limited thereto.

The first electrode layer 511b may be disposed on a first surface (or rear surface or lower surface) of the vibrating layer 511a. For example, the first electrode layer 511b of the first sub vibrating portion 511 adjacent to each other may be electrically connected to each other. For example, the first electrode layer 511b may have a single electrode shape disposed on the entire first surface (or lower surface) of each of the vibrating layers 511a, but embodiments of the present disclosure are not limited thereto.

The second electrode layer 511c may be disposed on the second surface (or a front surface or an upper surface) of the vibrating layer 511a. The second electrode layer 511c may have the same size as the vibrating layer 511a or may have a smaller size than the vibrating layer 511a. For example, the second electrode layer 511c may have the same shape as the vibrating layer 511a, but embodiments of the present disclosure are not limited thereto.

At least one of the first electrode layer 511b and the second electrode layer 511c according to an embodiment of the present disclosure may be formed of a transparent conductive material, a translucent conductive material, or an opaque conductive material.

The vibrating layer 511a may be polarized by a constant voltage applied to the first electrode layer 511b and the second electrode layer 511c in a constant temperature atmosphere or a temperature atmosphere changed from high temperature to room temperature, but embodiments of the present disclosure are not limited thereto.

The vibrating layer 511a may vibrate by alternately repeating contraction and/or expansion by a reverse piezoelectric effect by a driving signal applied to the first electrode layer 511b and the second electrode layer 511c from the outside. For example, the vibrating layer 511a may vibrate in a vertical direction (or a thickness direction) and a plane direction by a signal applied to the first electrode layer 511b and the second electrode layer 511c. The vibrating layer 511a may be displaced (or vibrated or driven) by contraction and/or expansion in the plane direction, thereby improving vibration characteristics including acoustic characteristics and/or sound pressure characteristics of the first vibration generating module 500.

The supporting member 540 may be provided between the cover member 560 and the vibrating portion 510. The supporting member 540 may be provided between the first cover member 561 and the first sub vibrating portion 511. The thickness T1 of the supporting member 540 may be 0.5 to 2.0 times the thickness of the vibrating layer 511a, but embodiments of the present disclosure are not limited thereto. For example, when the thickness of the supporting member 540 is less than 0.5 times the thickness of the vibrating layer 511a, the supporting member 540 may be damaged by vibration of the vibrating layer 511a. For example, when the thickness of the supporting member 540 exceeds 2.0 times the thickness of the vibrating layer 511a, vibration of the vibrating layer 511a may not be easily transmitted to the vibration member 20.

The supporting member 540 may be connected to the vibration portion 510. The supporting member 540 may be connected to a first surface (or rear surface) of the first sub vibrating portion 511. The supporting member 540 may be provided between the cover member 560 and the first sub vibrating portion 511. The supporting member 540 may be provided between the first cover member 561 and the first sub vibrating portion 511. The supporting member 540 may be configured to convert the in-plane vibration mode (or first vibration mode) of the first sub vibrating portion 511 into an out-of-plane vibration mode (or second vibration mode). For example, the supporting member 540 may include a metal material or a plastic material.

The flexible portion 520 may be configured to surround the first sub vibrating portion 511. The flexible portion 520 may be configured between a plurality of first sub vibrating portions 511. The flexible portion 520 may be configured to surround the remaining surface of the first vibrating portion 510 except for the upper surface and the side surface of the second electrode layer 511c.

According to an embodiment of the present disclosure, since the first vibration generating module 500 includes the flexible portion 520, vibration energy of the first sub vibrating portion 511 may be increased, and thus, vibration characteristics may be increased, and piezoelectric characteristics and flexibility may be secured. For example, the flexible portion 520 may be one or more of an epoxy-based polymer, an acrylic-based polymer, and a silicone-based polymer, but is not limited thereto.

For example, the flexible portion 520 may be formed of an organic material portion. For example, the organic material portion may absorb an impact applied to the inorganic material portion (or the vibration layer) by being disposed between the vibration layers 511a composed of the inorganic material portion. For example, the organic material portion may improve the durability of the first vibrating portion 510 by releasing stress concentrated on the inorganic material portion (or the vibration layer), and may provide flexibility to the first vibrating portion 510

The vibration apparatus 500 according to the embodiment of the present disclosure may further include a cover member 560. The cover member 560 may include a first cover member 561 and a second cover member 562.

The first cover member 561 may be disposed on a first surface (or a lower surface) of the first vibrating portion 510. The first cover member 561 is disposed on the first electrode layer 511b of the first sub vibrating portion 511, and may be configured to cover the first electrode layer 511b. The first cover member 561 may be configured to cover the supporting member 540. For example, the first cover member 561 may be configured to have a size larger than those of the first vibrating portion 510 and the supporting member 540. The first cover member 561 may be configured to protect a first surface (or a lower surface) and a first electrode layer 511b of the vibrating portion 510.

The second cover member 562 may be disposed on the second surface (or upper surface) of the vibration portion 510. The second cover member 562 may be disposed on the second electrode layer 511c of the first vibrating portion 510, and may be configured to cover the second electrode layer 511c of the first vibrating portion 510. For example, the second cover member 562 may be configured to have a size larger than that of the first vibrating portion 510, and may be configured to have the same size as that of the first cover member 561. The second cover member 562 may be configured to protect the second surface (or upper surface) and the second electrode layer 511c of the first vibrating portion 510.

The first cover member 561 may be connected to or coupled to a first surface of the first vibrating portion 510, the supporting member 540, and/or a first surface of the flexible portion 520 via a first adhesive layer 563. For example, the first cover member 561 may be connected to or coupled to a first surface of the first vibrating portion 510, the supporting member 540, and/or a first surface of the flexible portion 520 by a film laminating process using a first adhesive layer 563.

The second cover member 562 may be connected to or coupled to the second surface or the second electrode layer 511c of the first vibrating portion 510 via the second adhesive layer 564. For example, the second cover member 562 may be connected or coupled to the second surface or the second electrode layer 511c of the vibrating portion 510 by a film laminating process using the second adhesive layer 564.

Each of the first adhesive layer 563 and the second adhesive layer 564 according to the embodiment of the present disclosure may include an electrical insulating material capable of being compressed and restored while having adhesive properties. For example, each of the first adhesive layer 563 and the second adhesive layer 564 may include an epoxy resin, an acrylic resin, a silicone resin, or a urethane resin, but embodiments of the present disclosure are not limited thereto.

The first adhesive layer 563 and the second adhesive layer 564 may be configured between the first cover member 561 and the second cover member 562 to surround the first vibrating portion 510, the supporting member 540, and the flexible portion 520. For example, at least one of the first adhesive layer 563 and the second adhesive layer 564 may be configured to surround the first vibrating portion 510, the supporting member 540, and the flexible portion 520.

The first vibration generating module 500 according to an embodiment of the present disclosure may further include a signal cable 570. The signal cable 570 may include a first power supply line 571 and a second power supply line 572.

The first power supply line 571 may be provided between the first vibrating portion 510 and the first cover member 561. The first power supply line 571 may be formed between the first electrode layer 511b of the first vibrating portion 510 and the first adhesive layer 563. For example, the first power supply line 571 may be electrically connected to the first electrode layer 511b of the first vibrating portion 510 via an anisotropic conductive film.

The second power supply line 572 may be configured between the first vibrating portion 510 and the second cover member 562. The second power supply line 572 may be configured between the second electrode layer 511c of the first sub vibrating portion 511 and the second adhesive layer 564. The second power supply line 572 may be electrically connected to the second electrode layer 511c of the first sub vibrating portion 511.

The signal cable 570 may be electrically connected to a pad portion disposed in the vibration apparatus 10 or the first vibration generating module 500. The signal cable 570 may supply a vibration driving signal (or an sound signal) provided from the sound processing circuit to the first vibrating portion 510. For example, the pad portion may include a flexible printed circuit cable, a flexible flat cable, a single-sided flexible printed circuit, a single-sided flexible printed circuit board, a flexible multilayer printed circuit, or a flexible multilayer printed circuit board, but is not limited thereto.

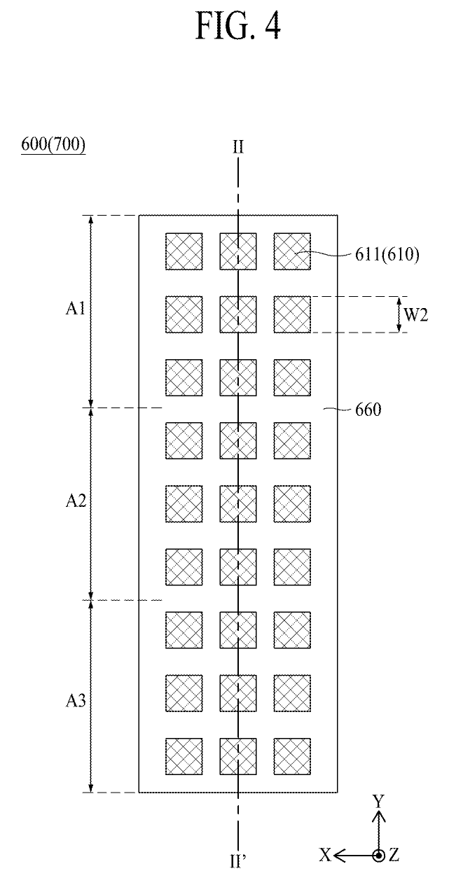

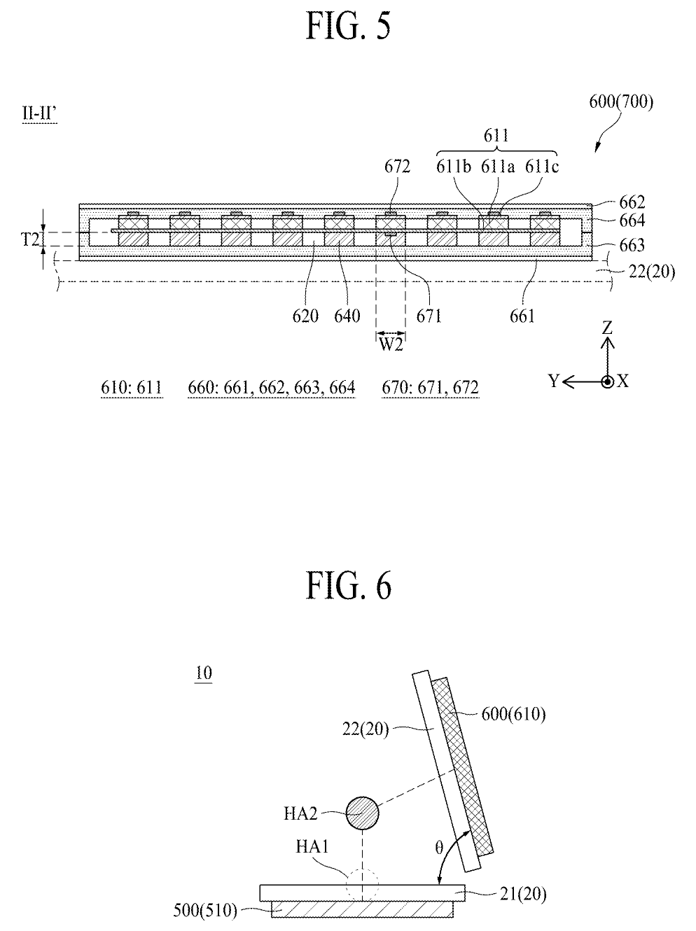

FIG. 4 is a plan view illustrating an example of a second vibration generating module illustrated in FIG. 1. FIG. 5 is a cross-sectional view taken along the line II-II′ shown in FIG. 4. This illustrates a second vibration generating module in an embodiment of the present disclosure described with reference to FIGS. 1 and 2. The second vibration generating module according to an embodiment of the present disclosure has a different configuration of the vibrating portion in the first vibration generating module described with reference to FIGS. 2 and 3. Therefore, hereinafter, the vibrating portion and a related configuration will be described, and the same configuration will be briefly described or omitted.

Referring to FIGS. 1, 4 and 5, the second vibration generating module 600 according to an embodiment of the present disclosure may include a second vibrating portion 610, a supporting member 640, a flexible portion 620, a cover member 660, and a signal cable 670.

The second vibrating portion 610 includes the same material as the first vibrating portion 510 described with reference to FIGS. 2 and 3, and may have the same structure except for a size or an area. Therefore, hereinafter, different configurations will be described.

The second vibrating portion 610 may be configured in the cover member 660. The second vibrating portion 610 may include a plurality of second sub vibrating portions 611 configured in the cover member 660. Each of a plurality of second sub vibrating portions 611 may be configured in each of the first to third regions A1 to A3 of the cover member 660. For example, a plurality of second sub vibrating portions 611 may be configured in each of the first to third regions A1 to A3. For example, 6 to 9 second sub-vibrating portions 611 may be arranged parallel to each of the first to third regions A1 to A3.

Each of a plurality of second sub vibrating portions 611 may be configured in parallel in a first direction X and a second direction Y perpendicular to the first direction X. Each of a plurality of second sub vibrating portions 611 may be configured in parallel in the first direction X. Each of a plurality of second sub vibrating portions 611 may be configured in parallel in a second direction Y perpendicular to the first direction X. Each of a plurality of second sub vibrating portions 611 may be spaced apart from each other by a predetermined distance.

Each of a plurality of second sub vibrating portions 611 may have the same size. For example, each of a plurality of second sub vibrating portions 611 may have a square shape, but embodiments of the present disclosure are not limited thereto. For example, the second width W2 of each of a plurality of second sub vibrating portions 611 may be 10 mm, but is not limited thereto. For example, the width, length, and thickness of each of a plurality of second sub vibrating portions 611 may be 10 mm, 10 mm, or 0.3 mm, but are not limited thereto. For example, in the vibration apparatus 10, the acoustic and/or sound pressure characteristics of the vibration apparatus 10 can be improved as the size of the vibrating portion containing the piezoelectric material increases, and the smaller the size of the vibrating portion, the better the directivity.

Referring to FIGS. 1 to 5, the second vibration generating module 600 according to an embodiment of the present disclosure may include a plurality of second sub vibrating portions 611 which are relatively smaller than the first vibration generating module 500. For example, a size of each of a plurality of second sub vibrating portions 611 may be smaller than a size of each of a plurality of first sub vibrating portions 511. For example, a size of each of a plurality of first sub vibrating portions 511 may be larger than a size of each of a plurality of second sub vibrating portions 611.

According to an embodiment of the present disclosure, the second vibration generating module 600 includes a plurality of second sub vibrating portions 611 having a smaller size than the first sub vibrating portion 511, thereby implementing ultrasonic vibration in the range of 25 KHz to 60 KHz. For example, the second vibration generating module 600 may be a directional speaker. For example, when the second vibration generating module 600 implements ultrasonic vibration in the range of 25KHz to 60KHz, the second vibration generating module (600) has directivity, so vibration or sound can be transmitted only to the user.

The second sub vibrating portion 611 according to an embodiment of the present disclosure may include a vibrating layer 611a, a first electrode layer 611b, and a second electrode layer 611c. In the second sub vibrating portion 611, configurations of the vibrating layer 611a, the first electrode layer 611b, and the second electrode layer 611c are the same as those of the first sub vibrating portion 511 described with reference to FIGS. 2 and 3, and thus will be briefly described below.

The vibrating layer 611a may include a piezoelectric material or an electroactive material including a piezoelectric effect. The first electrode layer 611b may be disposed on a first surface (or a rear surface or a lower surface) of the vibrating layer 611a. For example, the first electrode layer 511b of the second sub vibrating portion 611 adjacent to each other may be electrically connected. The second electrode layer 611c may be disposed on a second surface (or a front surface or an upper surface) of the vibrating layer 611a.

According to an embodiment of the present disclosure, since the second sub vibrating portion 611 has a different size from the first sub vibrating portion 511 described with reference to FIGS. 2 and 3, the vibrating layer 511a of the first vibration generating module 500 and the vibrating layer 611a of the second vibration generating module 600 may have different sizes. For example, the size of the vibrating layer 511a of the first vibration generating module 500 may be larger than the size of the vibrating layer 611a of the second vibration generating module 600.

Referring to FIGS. 1, 4, and 5, a supporting member 640 may be provided between the cover member 660 and the vibrating portion 610. The supporting member 640 may be provided between the first cover member 661 and the second sub vibrating portion 611. The supporting member 640 may be provided between the first cover member 661 and a plurality of second sub vibrating portions 611. For example, a plurality of supporting members 640 may be provided, but embodiments of the present disclosure are not limited thereto.

The flexible portion 620 may be configured to surround the second sub vibrating portion 611. The flexible portion 620 may be configured to cover a side surface of each of a plurality of second sub vibration portions 611.

In the second vibration generating module 600 according to an embodiment of the present disclosure, the configurations of the cover member 660 and the signal cable 670 are the same as those of the first vibration generating module 500 described with reference to FIGS. 2 and 3, and thus the description thereof is omitted.

According to an embodiment of the present disclosure, since the vibration apparatus 10 includes the second vibration generating module 600, the vibration apparatus 10 has directivity, there is an effect that vibration or sound may be easily transmitted only to the user.

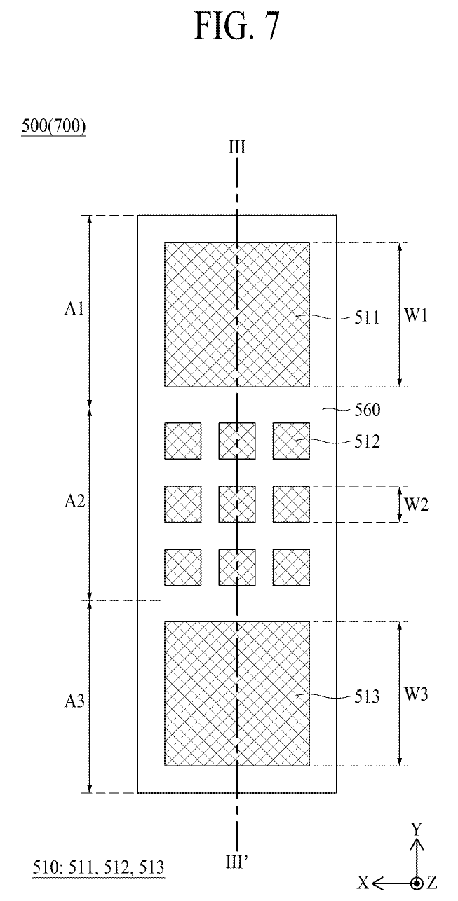

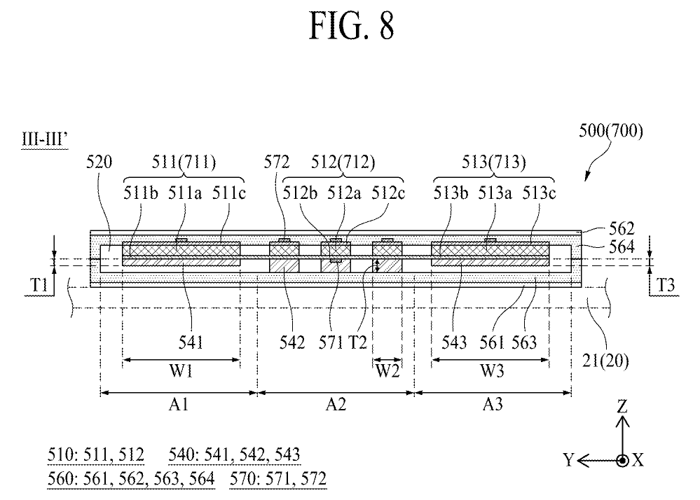

FIG. 6 is a side view schematically illustrating a vibration apparatus according to another embodiment of the present disclosure. FIG. 7 is a plan view illustrating an example of a first vibration generating module illustrated in FIG. 6. FIG. 8 is a cross-sectional view taken along the line III-III′ shown in FIG. 7. This shows a vibration apparatus according to another embodiment of the present disclosure, and is the same as the vibration apparatus according to an embodiment of the present disclosure described with reference to FIGS. 1 to 5, except that the configuration of the first vibration generating module is changed. Therefore, hereinafter, the first vibration generating module and a configuration related thereto will be described, and the same configuration will be briefly described or omitted.

Referring to FIGS. 6 to 8, a vibration apparatus 10 according to another embodiment of the present disclosure may be coupled to a vibration member 20. For example, the vibration member 20 may include a first vibration member 21 and a second vibration member 22.

According to another embodiment of the present disclosure, the vibration apparatus 10 may include a first vibration generating module 500 and a second vibration generating module 600. Each of the first vibration generating module 500 and the second vibration generating module 600 may be coupled to the vibration member 20.

The first vibration generating module 500 and the second vibration generating module 600 may have different structures. For example, a plurality of vibrating portions or the first vibrating portion 510 disposed in the first vibration generating module 500 may have different sizes and structures from a plurality of vibrating portions or the second vibrating portion 610 disposed in the second vibration generating module 600.

According to another embodiment of the present disclosure, the first vibration generating module 500 may include a first vibrating portion 510, a supporting member 540, a flexible portion 520, a cover member 560, and a signal cable 570. In the first vibration generating module 500 according to another embodiment of the present disclosure, configurations of the cover member 660 and the signal cable 670 are the same as those of the first vibration generating module 500 described with reference to FIGS. 2 and 3, and thus the first vibrating portion 510, the supporting member 540, and the flexible portion 520 will be described below.

The first vibrating portion 510 may include 1-1 to 1-3 sub vibrating portions 511, 512, and 513 disposed in parallel. Each of the 1-1 to 1-3 sub vibrating portions 511, 512, and 513 may be disposed in parallel in the second direction Y perpendicular to the first direction X. The 1-1 sub vibrating portion 511 may be located in the first area A1 of the cover member 560. The 1-2 sub vibrating portion 512 may be located in the second area A2 of the cover member 560. The 1-3 sub vibrating portion 513 may be located in the third area A3 of the cover member 560.

The first vibrating portion 510 may include one 1-1 sub vibrating portion 511 in the first area A1 of the cover member 560. The first vibrating portion 510 may include a plurality of 1-2 sub vibrating portions 512 in the second region A2 of the cover member 560. Each of a plurality of 1-2 sub vibrating portions 512 may be configured in parallel in the first direction X and the second

direction Y perpendicular to the first direction X. The first vibrating portion 510 may include one 1-3 sub vibrating portion 513 in the third region A3 of the cover member 560.

The 1-1 to 1-3 sub vibrating portions 511, 512, and 513 may be spaced apart from each other by a predetermined distance. The 1-1 sub vibrating portion 511 and the 1-3 sub vibrating portion 513 may have the same size. The 1-1 sub vibrating portion 511 and the 1-2 sub vibrating portion 512 may have different sizes. The 1-2 sub vibrating portion 512 may have a size smaller than that of the 1-1 sub vibrating portion 511. A single 1-2 sub vibrating portion 512 may have a smaller size than a single 1-1 sub vibrating portion 511. For example, the length W2 of one side of the 1-2 sub vibrating portion 512 may be smaller than the length W1 of one side of the 1-1 sub vibrating portion 511. For example, the length W1 of one side of the 1-1 sub vibrating portion 511 may be the same as the length W3 of one side of the 1-3 sub vibrating portion 513. For example, as the size of the vibrating portion 510 increases, acoustic characteristics and/or sound pressure characteristics may be improved, and as the size of the vibration unit decreases, directivity may be improved.

According to the embodiment of the present disclosure, the first vibration generating module 500 configures the 1-2 sub vibrating portion 512 having different sizes between the 1-1 sub vibrating portion 511 and the 1-3 sub vibrating portion 513, so that acoustic interference between a plurality of speakers may be prevented or minimized, and directivity, acoustic characteristics and/or sound pressure characteristics may be improved at the same time.

According to another embodiment of the present disclosure, each of the 1-1 sub vibrating portion 511 and a plurality of 1-2 sub vibrating portions 512 may include vibrating layers 511a and 512a, first electrode layers 511b and 512b, and second electrode layers 511c and 512c. Since the configuration of the 1-3 sub vibrating portion 513 is the same as that of the 1-1 sub vibrating portion 511, only the 1-1 sub vibrating portion 511 will be described below, and the configuration of the 1-3 sub vibrating portion 513 will be omitted.

The size of the vibrating layer 512a of the 1-2 sub vibrating portion 512 may be smaller than the size of the vibrating layer 511a of the 1-1 sub vibrating portion 511. For example, the length of the one side of the vibrating layer 512a of the 1-2 sub vibrating portion 512 may be smaller than the length of the one side of the vibrating layer 511a of the 1-1 sub vibrating portion 511. For example, the length of the one side of the vibrating layer 512a of the 1-2 sub vibrating portion 512 may be in the range of 15% to 25% of the length of the one side of the vibrating layer 511a of the 1-1 sub vibrating portion 511, but embodiments of the present disclosure are not limited thereto.

The first electrode layers 511b and 512b may be disposed on a first surface (or a rear surface or a lower surface) of the vibrating layers 511a and 512a. The second electrode layers 511c and 512c may be disposed on a second surface (or a front surface or an upper surface) of the vibrating layers 511a and 512a.

The supporting member 540 may be provided between the first cover member 561 and the 1-1 sub vibrating portion 511. The supporting member 540 may be provided between the first cover member 561 and the 1-2 sub vibrating portion 512. The supporting member 540 may be provided between the first cover member 561 and the 1-3 sub vibrating portion 513. The thickness of the supporting member 540 may be 0.5 to 2.0 times the thickness of the vibrating layers 511a and 512a, but embodiments of the present disclosure are not limited thereto. For example, when the thickness of the supporting member 540 is less than 0.5 times the thickness of the vibrating layers 511a and 512a, the supporting member 540 may be damaged by vibrations of the vibrating layers 511a and 512a. For example, when the thickness of the supporting member 540 is greater than 2.0 times the thickness of the vibrating layers 511a and 512a, the vibrations of the vibrating layers 511a and 512a may not be easily transferred to the vibration member 20.

The supporting member 540 may be configured to support the first vibrating portion 510 and transmit the vibration of the first vibrating portion 510 to the vibration member 20. For example, the supporting member 540 may be connected to the first vibrating portion 510 to adjust the resonance frequency of the vibration apparatus 500 to about 40 KHz band. For example, in the embodiment of the present disclosure, the resonance frequency of the vibration apparatus 500 may be reduced to about 40 KHz band by adjusting the material and thickness of the supporting member 540.

The supporting member 540 according to an embodiment of the present disclosure may include a first supporting member 541 and a second supporting member 542.

The first supporting member 541 may transmit the vibration of the 1-1 sub vibrating portion 511 to the vibration member 20. The first supporting member 541 may be configured to adjust a resonance frequency of the 1-1 sub vibrating portion 511 to about 40 kHz band. The first supporting member 541 may be configured between the cover member 560 and the 1-1 sub vibrating portion 511. The first supporting member 541 may be configured to convert the in-plane vibration mode (or first vibration mode) of the 1-1 sub vibrating portion 511 into an out-of-plane vibration mode (or second vibration mode).

The second supporting member 542 may transfer a vibration of the 1-2 sub vibrating portion 512 to the vibration member 20. The second supporting member 542 may be configured to adjust a resonance frequency of the 1-2 sub vibrating portion 512 in a band of about 40 kHz. The second supporting member 542 may be provided between the cover member 560 and the 1-2 sub vibrating portion 512. The second supporting member 542 may be provided between the first cover member 561 and a plurality of 1-2 sub vibrating portions 512. The second supporting member 542 may be connected to each of the first surface (or rear surface) of a plurality of 1-2 sub vibrating portions 512. For example, a plurality of second supporting members 542 may be provided, but embodiments of the present disclosure are not limited thereto. For example, a plurality of second supporting members 542 may be connected to each of a plurality of 1-2 sub vibrating portions 512.

According to an embodiment of the present disclosure, the first supporting member 541 and the second supporting member 542 may include the same material. For example, the first supporting member 541 and the second supporting member 542 may include a metal material or a plastic material.

According to an embodiment of the present disclosure, the first supporting member 541 may have a size corresponding to the 1-1 sub vibrating portion 511, and may have a size corresponding to the 1-2 sub vibrating portion 512 of the second supporting member 542, but embodiments of the present disclosure are not limited thereto. For example, the first supporting member 541 may have a first width W1 corresponding to the 1-1 sub vibrating portion 511. For example, the second supporting member 542 may have a second width W2 corresponding to the 1-2 sub vibrating portion 512 of the second supporting member 542. But, an embodiment of the present disclosure is not limited thereto.

According to an embodiment of the present disclosure, thicknesses of the first supporting member 541 and the second supporting member 542 may be different from each other. For example, the thickness T1 of the first supporting member 541 may be less than the thickness T2 of the second supporting member 542, but embodiments of the present disclosure are not limited thereto. For example, the thickness T1 of the first supporting member 541 may be equal to or less than 60% of the thickness T2 of the second supporting member 542.

For example, when the sizes of the 1-1 sub vibrating portion 511 and the 1-2 sub vibrating portion 512 are different, the resonant frequencies of ultrasonic waves output from each of the 1-1 sub vibrating portion 511 and the 1-2 sub vibrating portion 512 may be different from each other.

The vibration apparatus 500 according to the embodiment of the present disclosure may be configured such that each of the first supporting member 541 and the second supporting member 542 includes the same material and has different thicknesses in order to set the resonance frequency of the ultrasonic waves output from each of the 1-1 sub vibrating portion 511 and the 1-2 sub vibrating portion 512 to a similar range (or 40 kHz to 43 kHz), but embodiments of the present disclosure are not limited thereto.

Accordingly, when the first vibration generating module 500 according to the embodiment of the present disclosure generates ultrasonic vibration, ultrasonic waves output from the 1-1 sub vibrating portion 511 and the 1-2 sub vibrating portion 512 may have similar resonant frequencies. For example, the resonant frequency of the 1-1 sub vibrating portion 511 according to the embodiment of the present disclosure may be 42.9 kHz, and the resonant frequency of the 1-2 sub vibrating portion 512 may be 42.5 kHz. Accordingly, the first vibration generating module 500 according to the embodiment of the present disclosure may improve the acoustic and/or sound quality characteristics of the first vibration generating module 500 in the 1-1 sub vibrating portion 511, and have an effect of improving the directivity of the first vibration generating module 500 in the 1-2 sub vibrating portion 512. The 1-3 sub vibrating portion 513 according to another embodiment of the present disclosure may have the same configuration and effect as the 1-1 sub vibrating portion 511.

In addition, when the first vibration generating module 500 according to the embodiment of the present disclosure generates low-frequency vibrations, low-frequency vibrations may occur in the 1-1 sub vibrating portion 511 and the 1-3 sub vibrating portion 513, and touch haptic HA1 may be implemented through the 1-1 sub vibrating portion 511 and the 1-3 sub vibrating portion 513.

The flexible portion 520 may be configured to surround each of the 1-1 sub vibrating portion 511 to the 1-3 sub vibrating portion 513. The flexible portion 520 may be configured between the 1-1 sub vibrating portion 511 and the 1-2 sub vibrating portion 512 adjacent to each other, and between the 1-3 sub vibrating portion 513 and the 1-2 sub vibrating portion 512 adjacent to each other. The flexible portion 520 may be configured between each of a plurality of 1-2 sub vibrating portions 512.

Another embodiment of the present disclosure may include a second vibration generating module 600. The second vibration generating module 600 according to another embodiment of the present disclosure has the same configuration as the second vibration generating module 600 described with reference to FIGS. 4 and 6. Therefore, hereinafter, only the same configuration is described and different configurations are omitted.

Referring to FIGS. 4 to 8, in the second vibration generating module 600, the second vibrating portion 610 may include a plurality of second sub vibrating portions 611 disposed in parallel. The second vibrating portion 610 may include a plurality of second sub vibrating portions 611 disposed in parallel to the first direction X and the second direction Y perpendicular to the first direction X. The size of each of the plurality of second sub vibrating portions 611 may be the same.

According to another embodiment of the present disclosure, a size of the 1-1 sub vibrating portion 511 may be larger than a size of each of a plurality of second sub vibrating portions 611. A size of the 1-3 sub vibrating portion 513 may be larger than a size of each of a plurality of second sub vibrating portions 611. A size of the 1-2 sub vibrating portion 512 may be the same as a size of each of a plurality of second sub vibrating portions 611.

The first vibration generating module 500 according to another embodiment of the present disclosure may output a first sound by a first sound signal. The second vibration generating module 600 may output a second sound by a second sound signal that is the same as or different from the first sound signal. For example, the first sound may be a low frequency vibration in the range of 50 Hz to 500 Hz or an ultrasonic vibration in the range of 25 KHz to 60 KHz. For example, the second sound may be an ultrasonic vibration in the range of 25 KHz to 60 KHz.

According to another embodiment of the present disclosure, the first vibration generating module 500 may include a 1-1 sub vibrating portion 511 and a 1-3 sub vibrating portion 513 larger than the 1-2 sub vibrating portion 512. The 1-1 sub vibrating portion 511 and the 1-3 sub vibrating portion 513 may implement low-frequency vibrations in the range of 50 Hz to 500 Hz according to the first sound signal.

Accordingly, when a touch haptic HA1 is to be provided, the first vibration generating module 500 may implement low-frequency vibrations in the range of 50 Hz to 500 Hz. For example, the first sound may be a low-frequency vibrations in the range of 50 Hz to 500 Hz. For example, when the first vibration generating module 500 implements low-frequency vibrations in the range of 50 Hz to 500 Hz, the first vibration generating module 500 may implement a touch haptic (HA1) that generates tactile feedback as the user directly touches the first vibration member 21.

According to another embodiment of the present disclosure, the first vibration generating module 500 may include the 1-2 sub vibrating portion 512 having a smaller size than the 1-1 sub vibrating portion 511 and the 1-3 sub vibrating portion 513, and the second vibration generating module 600 may include the second sub vibrating portion 612 having the same size as the 1-2 sub vibrating portion 512. The 1-2 sub vibrating portion 512 may implement ultrasonic vibration in the range of 25 KHz to 60 KHz according to the first sound signal. The second sub vibrating portion 612 may implement ultrasonic vibration in the range of 25 KHz to 60 KHz according to the second sound signal. The 1-2 sub vibrating portion 512 of the first vibration generating module 500 and the second sub vibrating portion 611 of the second vibration generating module 600 may generate the same ultrasonic vibration.

Accordingly, the first vibration generating module 500 and the second vibration generating module 600 may implement a mid-air haptic HA2 or a second haptic HA2 between the first vibration generating module 500 and the second vibration generating module 600.

According to another embodiment of the present disclosure, when the first vibration generating module 500 and the second vibration generating module 600 implement ultrasonic vibration, the mid-air haptic HA2 may be implemented between the first vibration generating module 500 and the second vibration generating module 600. For example, the first sound of the first vibration generating module 500 may implement ultrasonic vibration in the range of 25 KHz to 60 KHz. For example, the second sound of the second vibration generating module 600 may implement ultrasonic vibration in the range of 25 KHz to 60 KHz.

For example, the mid-air haptic HA2 may be implemented by overlapping phase arrays such as a first vibrating portion 510 and a second vibrating portion 610 configured in each of the first vibration generating module 500 and the second vibration generating module 600. For example, overlapping can be caused by constructive and destructive interference depending on the waveform.

For example, when a user’s hand or a sensing signal is sensed between the first vibrating portion 510 and the second vibrating portion 610 adjacent to each other, the sensed sensing signal may be converted into a digital form and transmitted to the control system. The control

system may analyze the received information and determine what kind of haptic feedback is to be provided. According to the determined haptic feedback, the first vibration generating module 500 may output a first sound according to the first sound generation signal, and the second vibration generating module 600 may output a second sound according to the second sound generation signal. For example, the first sound and the second sound may output the same ultrasonic vibration. Accordingly, each of the first vibration generation module 500 and the second vibration generation module 600 may form an ultrasonic waves vibration or ultrasonic waves carrier. For example, ultrasonic waves generated from each of the first vibration generation module 500 and the second vibration generation module 600 may be moved through air. In this case, there may be a sudden change in acoustic impedance such as the user’s hand, and vibration may occur. For example, the generated vibration may be used for haptic feedback in mid-air. This process may be performed simultaneously with the user or the user’s hand entering a range within a preset area between the first vibration member 21 and the second vibration member 22, and the user immediately feels haptic feedback.

According to another embodiment of the present disclosure, each of the first vibration generating module 500 and the second vibration generating module 600 may be disposed to be spaced apart from each other by a predetermined distance. The first vibration generating module 500 and the second vibration generating module 600 may be disposed at a first angle θ. The second vibration generating module 600 may be disposed to have a first angle θ from the upper surface of the first vibration generating module 500. For example, the first angle θ may be 60° to 120°. For example, when the first angle θ is less than 60°, the distance between the first vibration generating module 500 and the second vibration generating module 600 is too close to implement the mid-air haptic HA2 by the user’s hand. For example, when the first angle θ exceeds 120°, the distance between the first vibration generating module 500 and the second vibration generating module 600 is too long to implement the mid-air haptic HA2 by the user’s hand.

According to another embodiment of the present disclosure, by arranging the first vibration generating module 500 and the second vibration generating module 600 to have a first angle θ, the second vibration generating module 600 may generate an ultrasonic vibration by the user’s hand recognized as a sensor to generate a tactile sensation. Accordingly, a first haptic (or touch haptic) by the first vibration generating module 500 may be implemented. A second haptic (or aerial haptic) may be implemented by the second vibration generating module 600.

According to another embodiment of the present disclosure, by configuring different sizes of the 1-1 sub vibrating portion 511 of the first vibrating portion 510 and the second sub vibrating portion 611 of the second vibration portion 610, acoustic and/or sound pressure characteristics may be improved in the first vibration generation module 500, a touch haptic may be implemented in the first vibration generation module 500, and directivity of the vibration device 10 may be improved in the second vibration generation module 600.

According to another embodiment of the present disclosure, by configuring the sizes of the 1-2 sub vibrating portion 512 of the first vibrating portion 510 and the second sub vibrating portion 611 of the second vibrating portion 610 to be the same, the mid-air haptic HA2 by ultrasonic waves may be implemented between the first vibration generating module 500 and the second vibration generating module 600.

According to another embodiment of the present disclosure, the vibration apparatus 10 includes a first vibration generating module 500 and a second vibration generating module 600 including a piezoelectric material, so that acoustic interference between a plurality of speakers may be prevented or minimized.

According to another embodiment of the present disclosure, since acoustic characteristics and/or sound pressure characteristics may be improved, the vibration apparatus 10 may be driven with low power, and there is an effect of reducing power consumption.

According to another embodiment of this specification, the vibration apparatus 10 includes a first vibration generating module 500 and a second vibration generating module 600 including a piezoelectric material, thereby simplifying the structure and making it easy to design.

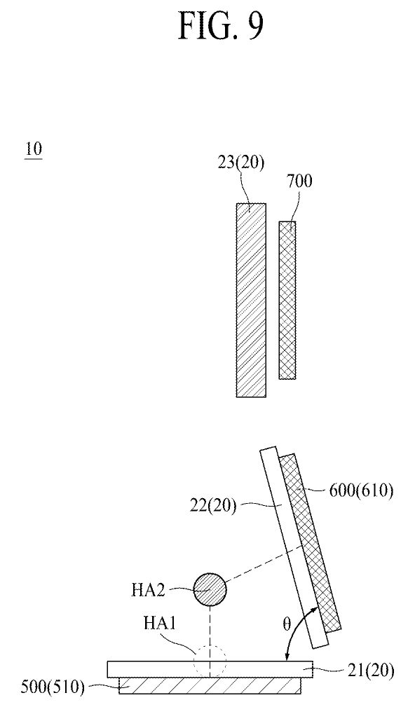

FIG. 9 is a side view schematically illustrating a vibration apparatus according to another embodiment of the present disclosure. This is to add the third vibration generating module in the embodiment of the present disclosure described with reference to FIGS. 6 to 8. Therefore, hereinafter, the third vibration generating module and a configuration related thereto will be described, and the same configuration will be briefly described or omitted.

Referring to FIG. 9, the vibration apparatus 10 according to another embodiment of the present disclosure may further include a third vibration generating module 700. The third vibration generating module 700 may be a directional speaker.

The third vibration generating module 700 may be spaced apart from the first vibration generating module 500 and the second vibration generating module 600. For example, the third vibration generating module 700 may be spaced apart from an upper end of the second vibration generating module 600 in order to minimize or reduce interference with the mid-air haptic HA2 between the first vibration generating module 500 and the second vibration generating module 600. For example, the third vibration generating module 700 may be spaced apart from an upper surface of the first vibration generating module 500 by at least 10 mm (e.g., a wavelength of 40 KH band in air). Accordingly, the third vibration generating module 700 may have directivity and transmit a sense of immersion to a user without affecting the mid-air haptic HA2 between the first vibration generating module 500 and the second vibration generating module 600.

A third vibration generating module 700 according to another embodiment of the present disclosure may be configured to output a third sound having directivity by being driven (or vibrated or displaced) by a third sound signal based on driving information. For example, the third sound signal may include an amplitude-modulated carrier signal, but embodiments of the present disclosure are not limited thereto. For example, the third sound signal may be generated by amplitude modulation of the driving information sound signal and the carrier signal corresponding to the driving information. For example, the third sound signal may be generated by amplitude modulation of the carrier signal based on the driving information sound signal corresponding to the driving information. For example, the carrier signal may be an ultrasonic signal or an ultrasonic carrier signal, but embodiments of the present disclosure are not limited thereto. For example, the third sound signal or the carrier signal may have a frequency of 25 kHz or more, but embodiments of the present disclosure are not limited thereto. For example, the third sound signal or the ultrasonic carrier signal may have a frequency of 40 kHz or more. Since the third sound according to an embodiment of the present disclosure has directivity by a carrier signal having a frequency of 25 kHz or more, it may be transmitted only to a user.

According to another embodiment of the present disclosure, the third vibration generating module 700 may have the same structure as the second vibration generating module 600 described with reference to FIGS. 4 and 5. Therefore, hereinafter, referring to FIGS. 4 and 5 together, different configurations will be described.

Referring to FIGS. 4, 5, and FIG. 9, the third vibration generating module 700 may have the same structure as the second vibration generating module 600. Accordingly, the first vibration generating module 500 may output a first sound by the first sound signal, and the second vibration generating module 600 and the third vibration generating module 700 may output a second sound and a third sound according to a sound signal different from the first sound signal.

According to another embodiment of the present disclosure, the first vibration generating module 500 may include a larger vibration portion than the second vibration generating module 600 and the third vibration generating module 700. Accordingly, the first vibration generating module 500 may implement low-frequency vibrations in the range of 50 Hz to 500 Hz. For example, the first sound may be a low-frequency vibrations in the range of 50 Hz to 500 Hz. For example, when the first vibration generating module 500 implements low-frequency vibrations, the first vibration generating module 500 may be a touch generation module, a touch vibration module, or a touch sound generation module capable of generating vibrations or sounds by a user’s direct touch.

According to another embodiment of the present disclosure, the second vibration generating module 600 and the third vibration generating module 700 may include a vibration portion having a size smaller than that of the first vibration generating module 500. Accordingly, each of the second vibration generating module 600 and the third vibration generating module 700 may implement ultrasonic vibration in the range of 25 KHz to 60 KHz. For example, each of the second sound and the third sound may implement ultrasonic vibrations in the range of 25 KHz to 60 KHz. For example, each of the second vibration generating module 600 and the third vibration generating module 700 may be a directional speaker implementing ultrasonic vibrations in the range of 25 KHz to 60 KHz. Accordingly, since each of the second sound and the third sound has directivity by a carrier signal having a frequency of 25 kHz or more, the second sound and the third sound may be transmitted only to a user.

According to another embodiment of the present disclosure, the size of the vibrating portion of the first vibration generating module 500 may be configured to be larger than the vibrating portion of each of the second vibration generating module 600 and the third vibration generating module 700. Accordingly, according to another embodiment of the present disclosure, acoustic and/or sound pressure characteristics may be improved in the first vibration generating module 500, touch haptic may be implemented in the first vibration generating module 500, and the directivity of the vibration apparatus 10 in the second vibration generating module 600 and the third vibrating generation module 700 may be improved.

According to another embodiment of the present disclosure, the third vibration generating module 700 may have the same structure as the first vibration generating module 500 described with reference to FIGS. 7 and 8. Therefore, hereinafter, referring to FIGS. 7 and 8, only different configurations will be described.

Referring to FIGS. 7 to 9, a third vibration generating module 700 may have the same structure as that of the first vibration generating module 500. Accordingly, the third vibration generating module 700 may include the sub vibration portion having the same size as that of the 1-2 sub vibrating portion 512. Since the 1-2 sub vibrating portion 512 has a smaller size than that of other sub vibrating portions, ultrasonic vibration in the range of 25 KHz to 60 KHz may be implemented. For example, the 1-2 sub vibrating portion 512 may have directivity.

According to another embodiment of the present disclosure, the first vibration generating module 500 may output a first sound by a first sound signal. The second vibration generating module 600 may output a second sound by a second sound signal that is the same as or different from the first sound signal. The third vibration generating module 700 may output a third sound by a third sound signal that is the same as or different from the first sound signal. For example, the first sound may be a low frequency vibration in the range of 50 Hz to 500 Hz or an ultrasonic vibration in the range of 25 KHz to 60 KHz. For example, the second sound may be an ultrasonic vibration in the range of 25 KHz to 60 KHz. For example, the third sound may be an ultrasonic vibration in the range of 25 KHz to 60 KHz.

According to another embodiment of the present disclosure, since the third vibration generating module 700 includes a 1-1 sub vibrating portion 711 and a 1-2 sub vibrating portion 712 having a smaller size than the 1-3 sub vibrating portion 713, ultrasonic vibration in the range of 25 KHz to 60 KHz may be implemented according to the third sound signal.

Accordingly, the third vibration generating module 700 according to another embodiment of the present disclosure may be a directional speaker capable of improving the directivity of the vibration apparatus 10.

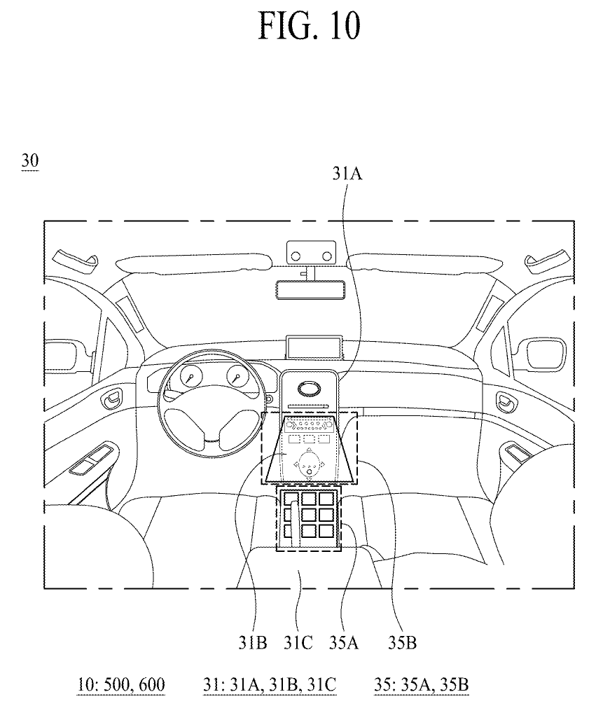

FIG. 10 is a diagram illustrating a vehicular apparatus according to an embodiment of the present disclosure.

Referring to FIG. 10, a vehicular apparatus 30 according to an embodiment of the present disclosure may include a vehicle interior material 31 and a sound generating apparatus 35.

The vehicle interior material 31 may output sound according to a vibration of the sound generating apparatus 35.

According to an embodiment of the present disclosure, the sound generating apparatus 35 may be disposed on a center fascia 31B of the vehicular apparatus 30. The sound generating apparatus 35 may be disposed on a center fascia 31B extending from the dash board 31A to the center console 31C. For example, the sound generating apparatus 35 may be disposed under the touch screen panel, and may be configured to output sound according to vibration of the touch screen panel by indirectly or directly vibrating the touch screen panel. For example, the sound generating apparatus 35 may be disposed under the display panel, and may provide sound to a user according to driving of the display panel. According to an embodiment of the present disclosure, since the sound generating apparatus 35 is a sound apparatus including the vibration apparatus described with reference to FIGS. 1 to 9, a redundant description thereof will be omitted.

According to an embodiment of the present disclosure, the sound generating apparatus 35 may include first and second sound generating modules 35A and 35B. For example, the first sound generating module 31A may output low-frequency vibrations in the range of 50 Hz to 500 Hz or ultrasonic vibrations in the range of 25 KHz to 60 KHz. For example, the second sound generating module 35B may output ultrasonic vibrations in the range of 25 KHz to 60 KHz. Each of the first and second sound generating modules 35A and 35B may be the same sound generating module as the first and second vibration generating modules described with reference to FIGS. 4 to 8.

According to an embodiment of the present disclosure, by configuring some of the sizes of the vibration units configured in each of the first sound generating module 35A and the second sound generating module 35B differently, the vehicular apparatus 30 including the sound generating apparatus 35 may improve acoustic characteristics and/or sound pressure characteristics in the first sound generating module 35A, a touch haptic may be implemented in the first sound generating module 35A, and the directivity of sound or vibration in the second sound generating n module 35B may be improved.

According to an embodiment of the present disclosure, by configuring some of the sizes of the vibration portion configured in each of the first sound generating module 35A and the second sound generating module 35B in the same manner, the vehicular apparatus 30 including the sound generating apparatus 35 may implement the mid-air haptic HA2 by ultrasonic waves between the first sound generating module 35A and the second sound generating module 35B.

According to an embodiment of the present disclosure, by including the first sound generating module 35A and the second sound generating module 35B including the piezoelectric material, the vehicular apparatus 30 including the sound generating apparatus 35 may prevent or minimize acoustic interference between a plurality of speakers.

According to an embodiment of the present disclosure, the vehicular apparatus 30 including the sound generating apparatus 35 can be driven with low power and has the effect of reducing power consumption because sound and/or sound pressure characteristics can be improved.

A vibration apparatus according to one or more embodiments of the present disclosure may be applied or included in a vibration apparatus disposed in the device. A apparatus according to an embodiment of the present disclosure includes a mobile device, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theatre apparatuses, theatre display apparatuses, TVs, wall paper display apparatuses, signage apparatuses, game machines, notebook computers, monitors, cameras, camcorders, and home appliances, or the like. Further, the vibration apparatus according to one or more embodiments of the present disclosure may be applied to or included in an organic light-emitting lighting apparatus or an inorganic light-emitting lighting apparatus. When the vibration apparatus is applied to or included in the lighting apparatuses, the lighting apparatuses may act as lighting and a speaker. In addition, when the vibration apparatus according to one or more embodiments of the present disclosure is applied to or included in the mobile apparatuses, or the like, the vibration apparatus may be one or more of a speaker, a receiver, and a haptic device, but embodiments of the present disclosure are not limited thereto.

It will be apparent to those skilled in the art that various modifications and variations can be made in the present disclosure without departing from the technical idea or scope of the disclosures. Thus, it is intended that the present disclosure covers the modifications and variations of this disclosure provided that within the scope of the claims and their equivalents.

The various embodiments described above can be combined to provide further embodiments. These and other changes can be made to the embodiments in light of the above- detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration apparatus comprising:
a first vibration generating module with a first vibrating portion; and
a second vibration generating module spaced apart from the first vibration generating module, the second vibration generating module including a second vibrating portion different from the first vibrating portion.

2. The vibration apparatus of claim 1, wherein:
the first vibrating portion and the second vibrating portion have different sizes.

3. The vibration apparatus of claim 1, wherein:
the first vibrating portion includes a plurality of first sub vibrating portions arranged in parallel, and
each of the plurality of first sub vibrating portions has the same size.

4. The vibration apparatus of claim 3, wherein:
the second vibrating portion includes a plurality of second sub vibrating portions arranged in parallel, and
each of the plurality of second sub vibrating portions has the same size.

5. The vibration apparatus of claim 4, wherein:
a size of each of the plurality of first sub vibrating portions is larger than a size of each of the plurality of second sub vibrating portions.

6. The vibration apparatus of claim 1, wherein each of the first vibrating portion and the second vibrating portion includes:
a vibrating layer containing piezoelectric material;
a first electrode layer on a first surface of the vibrating layer; and
a second electrode layer on a second surface different from the first surface of the vibrating layer,
wherein the vibrating layer of the first vibrating portion and the vibrating layer of the second vibrating portion have different sizes.

7. The vibration apparatus of claim 1, wherein:
the first vibration generating module outputs a first sound by a first sound signal; and
the second vibration generating module outputs a second sound by a second sound signal different from the first sound signal.

8. The vibration apparatus of claim 7, wherein:
the first sound is a low frequency vibration in the range of 50 Hz to 500 Hz; and
the second sound is an ultrasonic vibration in the range of 25 KHz to 60 KHz.

9. The vibration apparatus of claim 1, wherein the first vibrating portion includes 1-1 sub vibrating portion, 1-2 sub vibrating portion and 1-3 sub vibrating portion arranged in parallel, and
wherein a size of the 1-1 sub vibrating portion is the same as a size of the 1-3 sub vibrating portion and the size of the 1-1 sub vibrating portion is different from a size of the 1-2 sub vibrating portion.

10. The vibration apparatus of claim 9, wherein:
the second vibrating portion includes a plurality of second sub vibrating portions arranged in parallel, and
each of the plurality of second sub vibrating portions has the same size.

11. The vibration apparatus of claim 10, wherein:
the size of the 1-1 sub vibrating portion is larger than a size of each of the plurality of second sub vibrating portions; and
the size of the 1-2 sub vibrating portion is the same as a size of each of the plurality of second sub vibrating portions.

12. The vibration apparatus of claim 1, wherein:
the second vibration generating module is disposed to have a first angle relative to a plane defined by the upper surface of the first vibration generating module; and
the first angle is 60° to 120°.

13. The vibration apparatus of claim 1, wherein:
the first vibration generating module outputs a first sound by a first sound signal; and
the second vibration generating module outputs a second sound by a second sound signal that is the same as or different from the first sound signal.

14. The vibration apparatus of claim 13, wherein:
the first sound is a low frequency vibration in the range of 50 Hz to 500 Hz or an ultrasonic vibration in the range of 25 KHz to 60 KHz; and
the second sound is an ultrasonic vibration in the range of 25 KHz to 60 KHz.

15. The vibration apparatus of claim 1, further comprising a third vibration generating module spaced apart from the first vibration generating module and the second vibration generating module; and
wherein the third vibration generating module has the same structure as the second vibration generating module.

16. The vibration apparatus of claim 15, wherein:
the first vibration generating module outputs a first sound by a first sound signal;
the second vibration generating module outputs a second sound by a second sound signal different from the first sound signal; and
the third vibration generating module outputs a third sound by a third sound signal different from the first sound signal.

17. The vibration apparatus of claim 16, wherein:
the first sound is a low frequency vibration in the range of 50 Hz to 500 Hz or an ultrasonic vibration in the range of 25 KHz to 60 KHz; and
the second sound and the third sound are ultrasonic vibrations in the range of 25 KHz to 60 KHz.

18. The vibration apparatus of claim 9, further comprising a third vibration generating module spaced apart from the first vibration generating module and the second vibration generating module; and
wherein the third vibration generating module has the same structure as the first vibration generating module.

19. A vehicular apparatus comprising:
a vibration member exposed to indoor space; and
a sound generating apparatus that outputs sound to the indoor space,
wherein the sound generating apparatus includes a vibration apparatus according to claim 1.

20. The vehicular apparatus of claim 19, wherein:
the vibration member includes any one of a diaphragm, a vibration plate, a vibration substrate, a vibration panel, a sound plate, a sound panel, a passive vibration plate, a passive vibration member, a passive vibration panel, a sound output plate, a sound vibration plate, a display panel, a vehicle display panel, a vehicle device, a flexible device, a curved device, a touch panel, and a vehicle touch panel.
